(19) United States
(12) Patent Application Publication
(10) Pub. No.: US 2013/0321578 A1
(43) Pub. Date: Dec. 5, 2013

(54) Method of Acquisition, Storage and Use of Data Relating to a Three-Dimensional Video Stream, and Video Processing Apparatus Thereof

(71) Applicant: Roberto Dini, None (IT)

(72) Inventor: Roberto Dini, None (IT)

(73) Assignee: S.I.SV.EL.SOCIETA ITALIANA PER LO SVILUPPO DELL'ELETTRONICA S.P.A., None (TO) (IT)

(21) Appl. No.: 13/985,084

(22) PCT Filed: Feb. 13, 2012
(86) PCT No.: PCT/IB2012/050644

§ 371 Date: Aug. 14, 2013

(30) Foreign Application Priority Data
Feb. 15, 2011 (IT) TO2011A000127

(51) Int. Cl. H04N 13/00

(52) U.S. Cl. CPC H04N 13/0007
USPC 348/43

(57) ABSTRACT

A method for acquiring and storing data relating to a video stream selectable by a user through a video processing apparatus (300) includes the steps of: identifying the source of a video stream by way of at least one identification datum, the video stream having a coding and transport configuration adapted to produce a three-dimensional display; identifying the coding and transport configuration of the video stream through the acquisition of a configuration datum; establishing, by the video processing apparatus (300), an association between the at least one identification datum and the configuration datum and storing the association into storage (12) of the video processing apparatus (300) for a subsequent selection of the video stream.

The present invention relates to a video processing method and apparatus used in the field of video image reception and capable of reproducing a three-dimensional display.

More in particular, the invention relates to a method of acquisition, storage and fruition of data relating to the format of a video image stream adapted to be reproduced in three-dimensional mode, as well as to a video processing apparatus.

It is known that, in order to be able to exploit the three-dimensional effect introduced by binocular vision, it is necessary to provide a user's left eye and right eye with a device capable of reproducing the corresponding left and right images in a three-dimensional stream. In stereoscopic systems, this is done by transmitting both images in a single video stream, which therefore contains, for each frame of the scene, both the left image and the right image.

Numerous formatting techniques are currently in use for coding, transporting and distributing stereoscopic video streams depending on the different mode in which the images of the stereoscopic pair are represented. In a certain class of such formats, the left and right images of the frames that make up the video stream are placed into, the same frame (“frame packing”), so as to allow for the distribution of stereoscopic video streams within distribution systems already in use for the circulation of two-dimensional contents, more precisely High Definition (HD) contents. Said frame packing techniques are differentiated on the basis of parameters such as, for example, size, rotation, decimation or undersampling, representation, layout and frequency of transfer of the two images within the video stream. Among others, we can mention the “side by side” technique, wherein the two left and right images are placed into the same frame by halving the horizontal resolution value of each image, and the “top-bottom” technique, wherein the two left and right images are placed into the same frame, called composite frame, by halving the vertical resolution value of each image in accordance with various decimation or undersampling techniques.

According to a further technique used for arranging the two images, one of them is placed unchanged into a composite frame, while the other one is suitably broken up into several parts and placed into the frame space left empty by the first image. This type of configuration of the stereoscopic video stream will hereafter be referred to as “fragmented”.

For coding efficiency reasons, other techniques have also been proposed such as, for example, the “L+depth” technique, consisting of transmitting the left image plus a depth map. By combining these two pieces of information, the display apparatus can rebuild the three-dimensionality of the scene, obtaining the right image from the left one and from the depth map. Other similar techniques have also been proposed, which exploit the strong correlation between the two left and right images, such as, for example, the so-called “2D+Delta” coding.

Among the other techniques known in the art, it is worth mentioning the so-called “field alternative”, “line alternative”, “column alternative” and “L+depth+graphics+graphics-depth” techniques.

The above list of coding techniques is not exhaustive, because such techniques are continually evolving with the aim of improving the definition of the three-dimensional image, while trying to keep the video stream within certain limits of band occupation.

Each one of these frame packing, coding and display techniques has advantages and drawbacks, and may conjugate to the other ones in a more or less optimal manner. At any rate, such a variety of three-dimensional content representation and display techniques creates many content coding and transport configurations, resulting in the necessity of being able to recognize them in order to adapt the video stream to different three-dimensional reproduction techniques on a display apparatus (e.g. a screen or a projector).

This variety of coding and transport configurations is flanked by an increased production of three-dimensional contents, which are distributed in multiple forms, e.g. by storing them on Blu-ray and DVD media, by transmitting them through broadcast transport channels (satellite, cable or terrestrial), or by making them available for download from local area networks or geographic area networks, such as the Internet.

At present, there is no unified technique or reference standard for transmitting and displaying a three-dimensional video content in all environments of production, distribution and visualization of stereoscopic video contents. Also, there is no reference standard for signalling, within the video stream, the coding and transport configuration adopted to produce a three-dimensional effect which applies to all production, distribution and fruition environments, independently of the source (e.g. TV broadcaster, Blu-ray disk, Internet site), of the transport means (optical or electronic medium, air, cable, satellite) and of the reception and/or display device (e.g. with “frame alternation”, or with alternated rows or columns). Said signalling is useful to the display apparatus, which otherwise cannot properly interpret the video stream to be reproduced, unless expensive and sophisticated video stream analysis algorithms are used. Such algorithms generally require many software and/or hardware resources (which could be used for other purposes) and much time for their full execution.

In addition, video stream players and/or receivers may be fitted with numerous interconnection interfaces, e.g. DVI, HDMI, Display Port, USB, WiMAX, Wi-Fi, and of course may include built-in television tuners and Blu-ray or DVD readers and solid-state or optical electronic memories.

Each of these video streams or contents may adopt a different configuration for the coding and transportation of the three-dimensional content to be displayed, possibly on the same reception and/or display device. It may therefore be necessary, or at least appropriate, to support different configurations of the input stereoscopic video stream in one display device, which normally uses a display format of its own, different from the one (called “configuration” herein) used for coding and transport, so that a format conversion is required. Three-dimensional content reception and/or reproduction apparatuses are available on the market which are fitted with suitable graphic control interfaces or selectors on control units, through which the user must every time manually select the specific coding and transport configuration adopted by the received three-dimensional video stream to be represented, so as to ensure a correct three-dimensional reproduction on the associated display device.

In this context, the term “video stream” refers to a series of video frames, each containing one or more images or video data. The term “video data” refers to data containing information about the video content of the frames, e.g. a depth map in the case of the “L+depth” configuration. The decompressed images and video data contained in said frames have their own coding and transport configuration, which must be known to the display device for said images and video data to be reproduced correctly.

The above-described technology scenario is extremely complex and variegated, due to the high degree of complexity reached by players and/or receivers, to the numerous possible coding and transport configurations which are constantly in evolution, and to the absence of any unified reference standards for signalling and recognizing three-dimensional contents. It may thus happen that some radio-television broadcasters decide to adopt, for their own transmissions, configurations for coding and transporting three-dimensional stereoscopic contents which are different from one another, perhaps without using the same signalling standard or mode or without using any, hence leaving it up to the user to identify and select manually the configuration with which a given television signal is being received.

Some concrete examples of this situation are those cases wherein video contents are transmitted through radio-television signal transmission systems in which the three-dimensional content signalling data are absent or inconsistent because the apparatuses employed for coding and transmitting the three-dimensional contents cannot enter such data or because there are no television receivers capable of interpreting them.

In Italy, for example, a first service broadcast by the Rai networks may use three-dimensional contents having a different configuration than a second service broadcast by the Mediaset networks. For instance, a program broadcast by Rai may use three-dimensional contents configured with the “side by side” technique, while a service broadcast by Mediaset may use a “top-bottom” configuration. In both cases, the signalling data might not be correct or updated accordingly, e.g. due to insufficient personnel or economical resources, or to absence of apparatuses specifically used for that purpose, or because the transport configurations used by these broadcasters are known from other sources, so that the viewer can select them manually on the reception/reproduction apparatus after having been notified about them.

It may also happen that the standards for interfacing electronic apparatuses for reproducing and receiving three-dimensional contents (standards such as, for example Display port, HDMI or MPEG4 MVC) do not contain some coding and transport configurations in use on the market or have not been updated thereto. It often occurs that the player device cannot properly reproduce a three-dimensional video stream because it has not received the different transport configuration adopted for each content or has received a wrong value thereof, or that every time a user wants to gain access to a three-dimensional content, he/she has to manually enter the data about the coding and transport configuration of the three-dimensional content.

Finally, it may also happen that some three-dimensional video reception and/or reproduction apparatuses cannot, for any reason, read the configuration signalling transported along with the video stream, e.g. because it is impossible to update the decoding circuits or modules thereof which should recognize the configuration of the video stream in order to allow it to be properly displayed on a screen.

It is therefore one object of the present invention to provide a method of acquisition and storage of data relating to a three-dimensional video stream, as well as a related video processing apparatus, which allow the user to handle the processing of three-dimensional video streams in a simple and immediate manner, independently of the many possible coding and transport configurations that the video stream may have.

It is another object of the present invention to provide a method of acquisition and storage of data relating to a three-dimensional video stream, as well as a related video processing apparatus, which allow speeding up the reproduction of a video stream in accordance with the correct coding and transport configuration.

It is a further object of the present invention to provide a method of acquisition and storage of data relating to a three-dimensional video stream, ad well as a related video processing apparatus, which allow minimizing the operations to be carried out by a user in order to obtain a proper reproduction of a three-dimensional video stream.

In short, the present invention relates to a method of acquisition, storage and fruition of data relating to user-selectable video streams, as well as to a related video processing apparatus, wherein said video streams have a certain coding and transport configuration for producing a three-dimensional display. The video processing apparatus comprises a memory that stores identification data identifying the user-selectable video streams, configuration data identifying the video stream coding and transport configurations, and the established order of association between the video stream identification data and the video stream coding and transport configuration data. Every time the user selects a certain video stream identified by one of the stream identification data, the device outputs the configuration datum associated with the identification datum, without the configuration datum having to be entered each time by the user or obtained from images of the video stream through a suitable detection system.

Furthermore, when recalling a three-dimensional video stream already stored in accordance with the method of the present invention, the video processing apparatus must neither extract again, if present, the coding and transport configuration of the video stream, nor obtain it autonomously, if absent, by means of a complex and costly method of analysis and evaluation of the coding and transport configuration, since it can simply and immediately read it from a memory, with much faster access times than would be necessary to extract said configuration from a special metadatum included in the stream, or to obtain it through a partial or total analysis of the video content transported thereby, or, finally, to acquire it from the user through manual entry.

Further features and objects of the invention will be set out in the appended claims, which are intended as an integral part of the present description; the teachings of the invention will become more apparent from the following detailed description of a preferred but non-limiting example of embodiment thereof with reference to the annexed drawings, wherein:

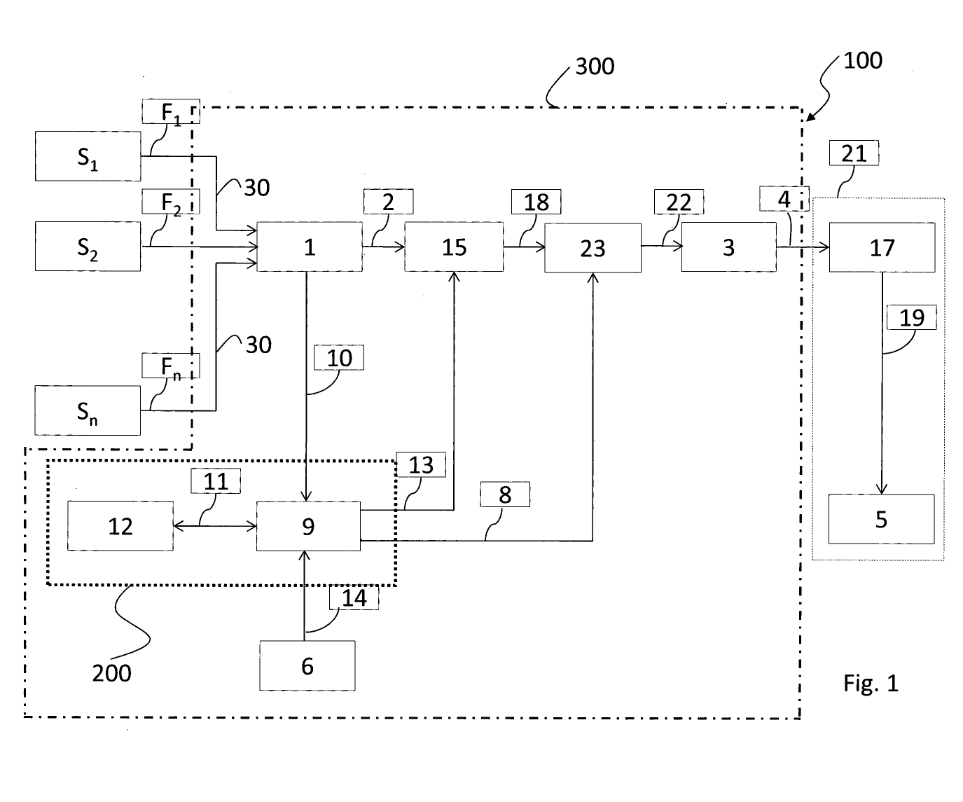

FIG. 1 is a block diagram of a system for reproducing two-dimensional and three-dimensional contents;

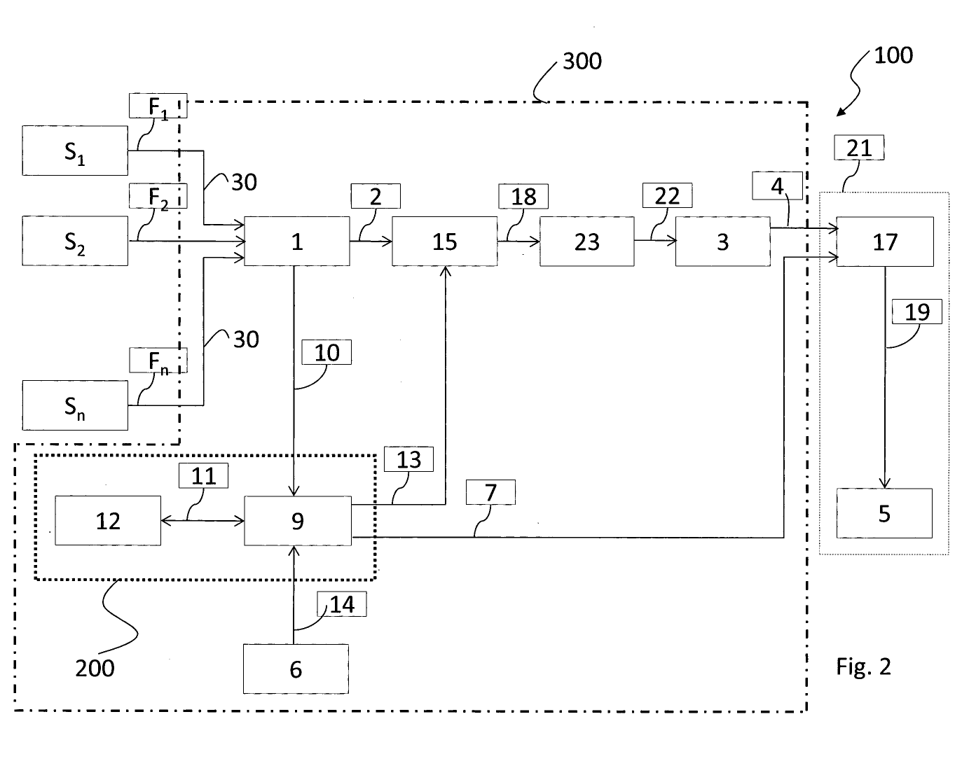

FIG. 2 is a block diagram of a reproduction system which is alternative to the one shown in FIG. 1;

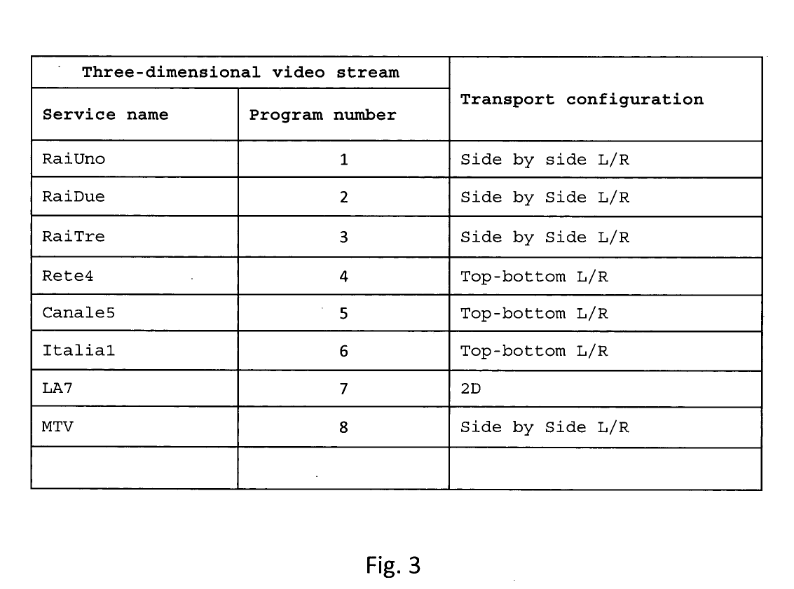

FIG. 3 shows an embodiment of a data structure which can be stored in a video processing apparatus according to the present invention;

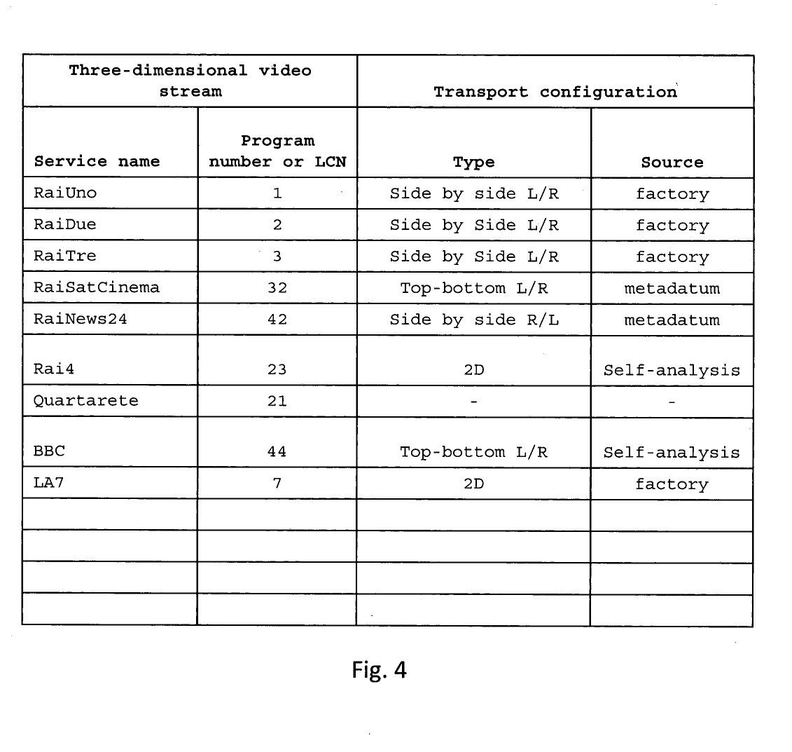

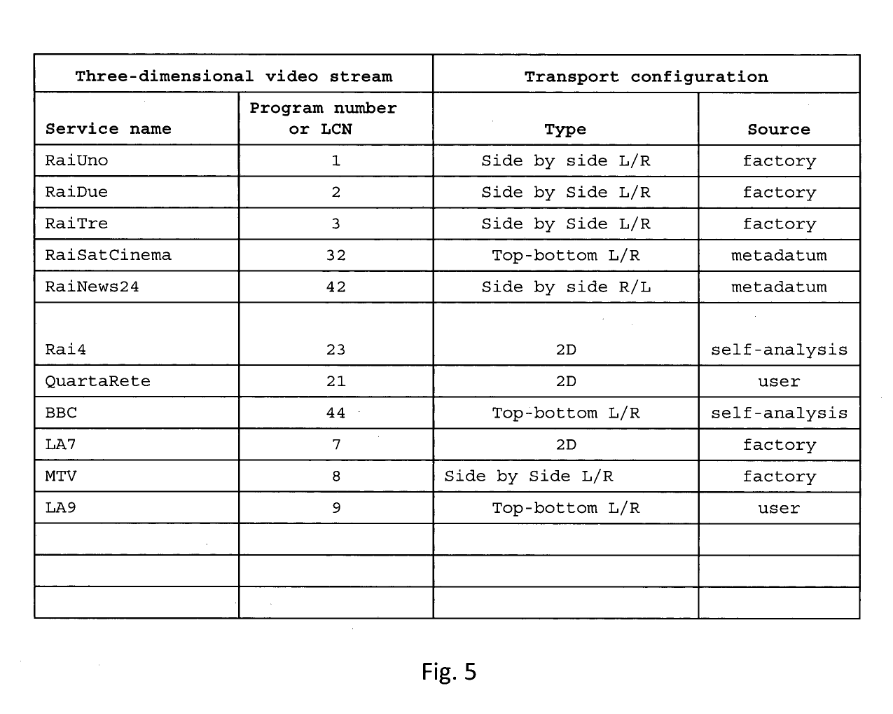

FIGS. 4 and 5 partially show a possible data structure being built, respectively at two successive time instants, which data can be stored in a video processing apparatus according to the present invention.

With reference to FIG. 1, there is shown a system 100 for acquiring and reproducing three-dimensional (and also two-dimensional) contents, which comprises:
a plurality of sources S₁, . . . Sₙ of three-dimensional signals (as well as two-dimensional signals), wherein said sources S₁, . . . Sₙ may, for example, take the form of readers or Blu-ray/DVD disks, tuners for receiving television transmissions, whether broadcast or previously recorded, memory readers using the USB interface, electronic memories (USB, flash disk, hard disk, solid-state) or optical memories, wireless interfaces, Ethernet cables, and the like;
a display apparatus 21 comprising a display device 5, adapted to display at least the video stream, and a display control unit 17, adapted to handle the activity of the display device 5; the display device 5 may be a screen of any type, e.g. LCD, plasma, back-projection or a video projector; in general, it may consist of any apparatus adapted to reproduce the images of a video stream in a form that can be perceived by the human eye;
a video processing apparatus 300; the apparatus 300 may, for example, be a television set, a set-top box, a video recorder, a computer, a cellular telephone, etc., and has the capability of acquiring and processing three-dimensional video contents.

The video processing apparatus 300 may in turn comprise:
a decoder 1, which acquires and decodes the data supplied by a source Sᵢ; said sources can be associated, generally one at a time, with the decoder 1 through a selection multiplexer device, not shown in the drawing;
a video processor 15, adapted to enter specific graphic interfaces into a video stream;
a data interface 3, adapted to supply the display apparatus 21 with data useful for displaying the video stream;
a control unit 23 for controlling the data interface 3, adapted to handle the activity of the data interface 3;
storage means 12, consisting of one or more memory areas, whether of the volatile or non-volatile type, adapted to store tables and other data structures;
a control module 9, adapted to output data useful for displaying three-dimensional and two-dimensional video streams;
a control unit 6, which outputs signals to the control module 9 in response to an operation executed by a user: the control unit 6 may be implemented in various manners, e.g. through a plurality of keys, a remote control and the like, so as to allow a user to select functions and issue commands.

As an alternative to what is shown in the drawing, one or more sources Sᵢ may be incorporated into the apparatus 300, depending on the source type, without any impact on the object of the present invention. In fact, in the case of a television receiver, for example, the i-th source Sᵢ may comprise a television tuner that receives television signals from any physical transmission means (cable or antenna), then demodulates them and outputs them to the decoder 1. On the other hand, in the case of a video stream included in a file stored in a semiconductor-type USB memory key, the i-th source Sᵢ consists of the external USB memory containing the file, which can be associated with the apparatus 300 through a physical USB interface port. The same applies to an external set-top-box or multimedia reader/player, which can be associated with the apparatus 300 through a physical interface of the SCART, HDMI, DVI, Cinch type or the like.

It must be pointed out that, at any rate, for the purposes of the present invention the display apparatus 21 may not be built in a video processing apparatus 300, but associated therewith or connected thereto through known connection means or data interfaces, whether wired (e.g. HDMI, DVI, Display port, SCART, RCA-Cinch) or wireless. When the display apparatus 21 is built in the apparatus 300, the interface may take the form of an internal data bus of the apparatus 300. In this latter case it is conceivable, as an alternative, that the control module 9 has a first output 7, directly connected to the display control unit 17 as shown in FIG. 2. The teaching of the present invention can be implemented regardless of the presence or absence of the display apparatus 21. The apparatus 300 comprises a processing device 200 that comprises the control module 9, the storage means 12 and means 10 for acquiring data identifying a video stream having a coding and transport configuration adapted to produce a three-dimensional display and data identifying said transport configuration.

The source Sᵢ generates or acquires a three-dimensional video content and sends it over a data line 30, in the form of a transport stream F, to the decoder 1. In this context, the term “transport stream” refers to a stream of information containing the data of a compressed or decompressed video stream and a set of metadata relating to that video stream, adapted to be transported on a specific transport means. Each one of the sources S₁, . . . , Sₙ provides a transport stream F₁, . . . , Fₙ through a corresponding data connection line 30.

In particular, the transport stream Fᵢ present on the data line 30 includes a set of metadata which, among other information, may also contain information that identifies the source and/or the content of the video stream. These identification data may be partially integrated with information added by the apparatus 300, such as, for example, the program number under which a given video stream received by a TV tuner has been stored or the identifier of the communication port (SCART, USB, AV1, EXT1, DVI, HDMI1, HDMI2 and the like) where the video stream is in transit.

In the case of a coded video stream, the decoder 1 can decompress the data relating to the compressed video stream, contained in the transport stream Fᵢ supplied by the data line 30, or anyway it can extract the video stream Fᵢ from the generic transport stream Fᵢ supplied by the generic data line 30, and send the same video stream to the video processor 15 through a second output 2. At the second output 2 of the decoder 1 a video stream is thus obtained which contains the images packed into the transport stream Fᵢ supplied by the data line 30. The images take a particular transport configuration within the video stream Fᵢ, so as to produce, on the display device 5, a visualization having the purpose of creating a three-dimensional effect.

The control module 9 controls the activity of the video processor 15 through a third output 13, based on the value of which the video processor 15 will operate in different modes.

In a first mode of operation, the video processor 15 simply outputs the video stream.

In a second operating mode, the video processor 15 processes the contents of the video stream so as to obtain a modified video stream containing a suitable graphic interface intended for the user. The video stream or the modified video stream containing the graphic interface are sent through a connection 18 to the data interface control unit 23. The control unit 23 sends to the data interface 3, through a fourth output 22, a transport stream adapted to be transported over the data interface 3 and containing the video stream. A video stream transport configuration value is entered into the metadata of the transport stream, said configuration being sent to the control unit 23 through a fifth output 8 of the control module 9. The transport stream is then sent, through the data interface 3, to the display apparatus 21, in particular to the display control unit 17, which processes said transport stream so as to provide the display device 5 with a display format compatible therewith.

In both operating modes of the video processor 15, it is conceivable that the control module 9 sends to the video processor 15 through the third output 13, in response to the selection of a video stream or anyway to a suitable command issued by the user, a signal containing the coding and transport configuration value of the selected video stream. The video processor 15 enters, in a graphic form that can be recognized by the user, the information about the coding and transport configuration value of the images making up the selected video stream. In this way, the user can read the coding and transport configuration of the selected video stream on the display device 5.

The decoder 1 extracts the metadata containing the information identifying the source of the three-dimensional video content, possibly associated with other data previously associated therewith by the apparatus 300 or otherwise obtainable from the latter (e.g. from the program number or from the source port).

The control module 9 receives the metadata through a first input 10 and extracts from said metadata the data that identify the video stream. In the case of transport streams coming from television broadcasters, each television broadcaster (e.g. RAI) has its own identification code for each distributed service or program. For example, in the case of digital terrestrial broadcasting, said identification code is the LCN information (“Logic Channel Number”), which is used by suitable television receivers for the purpose of automatically assigning to the service being received a predefined position in the list of received services. In the extreme case wherein a certain broadcaster always broadcasts stereoscopic video streams having the same configuration, one may even store into a table having a structure like the one shown in FIG. 3, or into an even simpler table comprising the coding and transport configuration, only the program number under which said service was stored into the program table by the apparatus 300, so that it can be selected by the user for subsequent selection and for playback by, for example, entering the corresponding program number by using the numeric keys of the control unit 6 or the up/down keys for incrementing and decrementing the program number (“zapping”).

FIG. 3 shows a data structure comprising, for example, the following fields: service name, program number, and coding and transport configuration, even though, in general, as already mentioned, the LCN code is sufficient because it generally coincides (save for any conflicts which can be solved in various ways) with the program number with which the video stream of a certain television station is associated in the program table. The usefulness of said data structure will be further explained later on. Advantageously, this very table may also contain the tuning information necessary for displaying the television service on an associated video reproduction device when the associated program number is selected.

Once the video stream identification datum has been acquired, the control module 9 verifies if in the storage means 12, to which it is connected through a data exchange line 11, a configuration datum, which identifies the coding and transport configuration of the images belonging to the stream itself, has already been associated with said three-dimensional video stream identification datum. If it has, the configuration identified by the configuration datum is automatically supplied, through the fifth output 8 of the control module 9, to the control unit 23 of the data interface 3, as shown in FIG. 1. The three-dimensional video stream can thus be displayed correctly, since the signal sent to a second input 4 of the display apparatus 21 comprises both the video stream and the transport configuration associated therewith through the control module 9. As an alternative, the configuration identified by the configuration datum may be automatically supplied, through the first output 7, directly to the display control unit 17, as shown in FIG. 2.

It is however possible that said association turns out to be incorrect, e.g. because the previously defined association is wrong or because it has not been updated to a new transmission configuration value. The user can thus detect a wrong visualization of the video stream on the display device 5 and, through the control unit 6, send through a sixth output 14 a control signal signalling a wrong visualization due to a wrong or outdated association contained in the storage means 12. Upon receiving the control signal, the control module 9 operates in accordance with a first association and storage procedure in order to acquire from the user the correct configuration to be associated with the identification datum corresponding to the video stream being displayed on the display device 5.

In the first association and storage procedure, the control module 9 requests to the video processor 15, through the second output 13, to operate in the second operating mode already described, i.e. to enter a graphic interface into the images that make up the video stream; in particular, the graphic interface contains a request, addressed to the user, to enter the transport configuration of the currently selected video stream. The user then enters the transport configuration through the control unit 6; the corresponding user control signal is then sent to the control module 9 through the sixth output 14 of the control unit 6.

Should the user not know the configuration, he/she might nevertheless proceed by trial and error, with the help of the graphic interface and of the control unit 6, according to an interactive dialogue method controlled by the control module 9 and by the video processor 15. For example, in a first interactive dialogue embodiment, the display apparatus 21 applies in sequence, one after the other, the adaptations required by the video stream to be correctly displayed on the display device 5, assuming that it has one of the supported configurations. The user can each time verify whether the display is correct or not, i.e. if the three-dimensional effect is being reproduced correctly on the screen. In such a case, he/she can signal to the display apparatus 21, through the control unit 6, that the assumption just made about the configuration of the video stream presented on the screen is correct, and the display apparatus 21 can then associate in its own memory the identification data of the properly displayed video stream with the configuration assumed as correct and signalled as such by the user. In general, it may happen that for said three-dimensional video stream no association with a coding and transport configuration datum has been stored. In this case, the control module 9 may, for example, remain waiting for a wrong display signalling command issued by the user, due to the absence of said association in the storage means 12, in response to which it will again operate in accordance with the above-described first association and storage procedure in order to acquire the transport configuration and associate it with the video stream. As an alternative to the first procedure, a second association and storage procedure may be conceived, wherein it is the control module 9 that makes the association between the identification datum and a configuration datum chosen on the basis of a certain association criterion. The association criterion may be arbitrary, i.e. the control module 9 may associate with the identification datum a configuration datum chosen randomly.

Alternatively, the association and storage criterion may be of the statistic type. Based on suitable statistic algorithms, the control module 9 associates the most probable configuration datum with the identification datum; or the association criterion may be of the deterministic type, so that the control module 9, based on suitable analyses of the video stream, associates with the identification datum that configuration datum which it considers to be the correct one, and then stores this association into the storage means 12.

A third association and storage procedure makes a combined use of the two procedures described above. Initially the control module 9 automatically makes the association by following the second association and storage procedure; if however the user detects a wrong visualization of the video stream on the display device 5, he/she can issue, through the control unit 6, a wrong display signalling command. Upon receiving the wrong display signalling, the control module 9 starts the first association and storage procedure in order to acquire from the user the correct configuration to be associated with the identification datum corresponding to the video stream being displayed on the display device 5.

As an alternative, the video stream with an unknown configuration may be forwarded to a device (not shown in FIGS. 1 and 2) capable of analyzing it and extrapolating from it, through suitable algorithms, the transmission configuration of the stream itself, provided of course that the apparatus 300 includes such a device.

As aforementioned, the coding and transport configuration may even take a value indicating a non-three-dimensional video stream, i.e. a two-dimensional one. In particular, if the selected video stream is actually a two-dimensional one, the user can, after signalling the wrong visualization and displaying the configuration entry graphic interface, enter a coding and transport configuration indicating a two-dimensional video stream. Through the control module 9, the association between the two-dimensional coding and transport configuration datum and the identification datum of the selected video stream may possibly be stored into the storage means 12.

In the case of three-dimensional contents coming from television broadcasters, a coding and transport configuration of the images contained in the three-dimensional video stream may be associated not only with a service identification code (e.g. the LCN code indicating the service in the DVB-T standard), but also with the service name, e.g. RaiUno, or a commercial icon representing it, such as the stylized RaiUno butterfly.

It is also advantageous that, when the apparatus 300 is installed, updated or reinstalled and the program table is generated, the processing device 200 allocates a part of said table to the associations between broadcaster identifiers (broadcaster name or code, which in this case constitute the video stream identification data) and the respective coding and transport configuration data. In a preferred embodiment of the invention, during the procedure for installing or reinstalling or updating the program table of the apparatus 100, the processing device 200 automatically attempts to associate with the video stream the respective coding and transport configuration that characterizes it, in accordance with at least one possible automatic procedure, i.e. chosen among all those procedures which do not require a manual action by the user. A first one of such procedures consists in verifying if in the same video stream there is a coding and transport configuration identifier, by verifying the presence thereof in any one of the fields or metadata where it might be present; a second procedure consists in trying to determine said configuration on the basis of an analysis of at least a portion of the decoded video content of the stream. In both cases, if said identifier is detected or deduced with sufficient confidence, it will be automatically associated with the video stream. These two automatic procedures may be implemented together or separately in the same processing device 200, depending on the design choices made by the manufacturer.

In the event than none of the available automatic procedures is successful, it is advantageous that the processing device 200 offers the user the possibility of manually entering the configuration data, at least for those video streams (whether or not stored in the program table) whose value cannot be recognized automatically. For example, at the end of the programming, re-programming or program update procedure, the processing device 200 may ask the user to manually enter the configuration data of the respective video streams of the television broadcasters stored in the table, by using the interactive dialogue method previously described.

In a preferred embodiment of the present invention, at least some of the associations between stream identification data and coding and transport configurations used by the control module 9 in order to automatically associate the three-dimensional video streams with the image coding and transport configurations can be stored beforehand into the storage means 12 at the factory by the manufacturer of the apparatus 300 on the basis, for example, of information provided by three-dimensional content providers in a suitable data structure, e.g. a table, a list or any other equivalent form of representation. FIG. 3 shows a possible implementation of said data structure in table form, specifically conceived for television transport video streams.

In the presence of this preferred embodiment of the invention, the control module 9 can proceed as follows when the apparatus 300 is installed or reinstalled. Once a video stream having a certain stream identification datum is found during the scanning process, the control module 9 verifies if in the data structure preset by the manufacturer there is an association with the coding and transport configuration relating to that video stream. Assuming that said association is present, the control module 9 stores into the data structure or program table being built, shown in FIG. 4, the association between the identified stream identification datum and the transport configuration retrieved from the data structure preset at the factory by the manufacturer, shown by way of example in FIG. 3. Let us assume, for example, that during the television service search phase the control module 9 has found a video stream having at least one identification datum (e.g. the name and/or the LCN code and/or the television service code) corresponding to that of broadcaster RaiUno. In such a case, while building the data structure of FIG. 4 the control module 9 verifies if in the preset data structure of FIG. 3 there is a coding and transport configuration predefined by the manufacturer for RaiUno, finding that there is one such configuration whose value is, in the example of FIG. 3, “Side by Side L/R”. The control module 9 then enters into the data structure being built, shown in FIG. 4, the association RaiUno—Side by Side L/R. If there is an LCN code, it is possible to use this datum, whether alone or in combination with the service code or name of RaiUno, as an identification datum of the video stream belonging to that broadcaster.

Said preset data structure can be used for storing at the factory the associations of any type of video stream that is suitable for three-dimensional reproduction; in the event that it is not, this can be signalled through a specific datum (see for example broadcaster “LA7” in FIG. 3). The data structure can then be used, for example, also to indicate which video streams are not suitable for three-dimensional reproduction.

If the identified service is not included in the preset table, the apparatus 300 can, for example, verify if it is present in some video stream metadata previously entered by the provider and/or by the distributor of the television signal, and then associate the latter with the service concerned in the data structure being built. In the case of FIG. 4, this occurs for the services RaiSatCinema and RaiNews24.

If neither of the above cases occur, the apparatus 300 according to the present invention may advantageously implement a method for detecting the coding and transport configuration based on the analysis of the video content of the three-dimensional stream, as it has been assumed herein to occur for the service Rai4. It should be noted that in the case shown in FIG. 4 the coding and transport configuration self-analysis procedure has given the result that the respective video stream of Rai4 is two-dimensional (“2D”).

FIG. 5 shows a situation of the data structure at a later time instant than the one of FIG. 4. In the particular embodiment shown herein, it is assumed that at the end of a fully automatic first scanning step, and without any user intervention, the apparatus asks the user to manually enter the coding and transport configuration of those services for which it has not been able to retrieve it autonomously. it may happen, in fact, that the following three circumstances occur simultaneously, which prevent the apparatus 300 from automatically associating the coding and transport configuration with the video stream: the table data structure preset by the manufacturer contains no configuration; no metadata describing the transport configuration is contained in the video stream; the self-analysis method has not been implemented in the apparatus, e.g. because it was considered to be too costly, or because, although present, has not provided a sufficiently reliable confidence level.

In such a case, it may advantageously be conceived that the apparatus asks the user to enter the missing configuration through any interactive dialogue, such as the one already described.

In the example shown in FIG. 5, the above-mentioned three circumstances occur for the services QuartaRete and LA9. In this case, the apparatus 300 according to the invention may ask the user to manually enter the transport configuration used by these two services. This can be done either at the end of the step of automatically scanning and storing the received television stations or by interrupting the same as soon as the apparatus realizes to be unable to autonomously determine the coding and transport configuration that characterizes the service just tuned and found.

Optionally, it is conceivable that the data structure partially represented during its construction in FIGS. 4 and 5 contains an additional field that specifies the source from which the transport configuration has been determined. This can be useful for information purposes and for implementing any priority criteria for assigning the transport configuration, should any conflicts arise between signallings coming from different sources (factory preset table, video stream metadata, self-analysis system, user).

The video streams with a defined coding and transport configuration may even comprise only a part of those commonly present in distribution chains, in that new sources of such streams may be continually introduced in the future, e.g. new 3D television stations, which are not yet active when the apparatus is manufactured. In any case, said preset data structure can be subsequently updated, whether remotely (e.g. by downloading firmware updates over the air) or locally (e.g. through a semiconductor memory associated with a USB port).

Within the frame of the procedure for automatically assigning the coding and transport configurations, different management policies may be adopted depending on the available methods of association. In fact, it is even possible to implement in the same apparatus 300 more than one procedure for automatically assigning coding and transport configurations to user-selectable video streams. For example, the same apparatus 300 may provide automatic association based on the data structure preset by the manufacturer, automatic association based on reading a metadatum, and possibly also automatic association based on the analysis of the video content of the transport stream. This increases the probability that the coding and transport configuration is automatically detected by the apparatus 300, i.e. without requiring the user's intervention; it may happen, in fact, that one of the adopted methods gives no result, while a different method is successful.

This also increases the reliability of the association made: in fact, the processing device 200 may contemporarily use two or more automatic association methods, compare the results, and then save the association only if the results are congruent. If the results are in conflict with each other, one may, for example, decide in accordance with criteria defined by the manufacturer, i.e. give preeminence to a method considered to be the most reliable one: for example, priority may be given to the metadatum included in the video stream over the one present in the preset data structure, assuming that the broadcaster keeps constantly updated the coding and transport configuration datum with which it is transmitted. Alternatively, the apparatus 300 may be made to ask the user to resolve any conflicts, or to effect a mixed strategy wherein the user is only asked to intervene at the end of the automatic installation procedure for those video streams for which the automatic methods have given ambiguous or contradictory configuration data as a result.

The apparatus 300 may also be made to carry out two or more automatic association methods serially, according to a certain predetermined order defined at the factory and/or definable or redefinable by the user, wherein a certain automatic method is used for a certain video stream if the higher priority method has not given a positive or valid result.

Advantageously, the preset data structure is stored into a non-volatile memory, so as to avoid that the data entered at the factory might be lost in the event of an interruption of the power supply to the apparatus 300. The same applies to the data structure generated by the control module 9, e.g. once it has been validly constructed for a sufficient number of user-selectable video streams.

It is also conceivable that factory associations, as well as those associations generated by the control module 9, can be subsequently modified by the user, or that the user can add new ones. In the present description, the expression “to define an association” means to enter a new association into the association list. Conversely, “to redefine an association” means, in a first case, to change the value of at least one of the two components of the association, i.e. the configuration datum and the identification datum, or, in a second case, to remove the association itself from the data structure (table or list) that contains it.

Associations can be defined or redefined by the user with several options. For instance, a first option is the use of the association and storage procedures previously described. A second option may give the user access to the entire association list: in this way, the user can define or redefine multiple associations by means of a single procedure. By using the control unit 6, the user can issue through the sixth output 14 an association list modification request command; in response to said command, the control module 9 reads, through the data exchange line 11, the data structure representing the list from the storage means 12. Then the control module 9, through the third output 13, sends to the video processor 15 a request for entering into the video, stream being displayed a graphic interface that allows the user to modify the entire association list. Said list may be an integral part of the program table that contains all the stored television services with the associated tuning information. Finally the user, through the control unit 6, can issue one or more commands adapted to modify the association list: in response to these commands, the control module 9 updates the data structure contained in the storage means 12 through the data exchange line 11.

It is also conceivable that, in order to help the user, the graphic display of said list also enumerates the identifiers of video streams not yet associated with a specific transport stream, such as, for example, a graphic interface containing a complete list of the television broadcasters included in the program table generally present in the apparatus 300. The term “program table” refers to a table or list containing an association between the program numbers selectable by the user through the control unit 6 and the radio-television broadcasters that the apparatus 300 can possibly be tuned to, independently of the source and of the transport means employed for their distribution. Said program table may be contained in the storage means 12 or in a separate memory area (not shown in the drawings). In this way, the user can define new associations for multiple video streams not currently selected for display.

As an alternative, it is possible to transmit to the control module 9 and/or to the storage means 12 a software update, which may also be periodical, containing information about said associations. The software update may be automatically downloaded, for example, if one of the sources Sᵢ is an Internet interface; when a source Sᵢ is a DVB signal tuner, it may be transmitted over a radio broadcasting channel or another distribution network (e.g. Internet, satellite). Once extracted from the decoder 1, the software update is sent to the control module 9 through the first input 10. Of course, hybrid solutions may also be conceived, which make a combined use of two or more of the above-described possibilities.

The layout of the functional elements described above and illustrated in FIG. 1 and FIG. 2 is wholly exemplary and constitutes a simple block diagram representing one embodiment of the device according to the present invention. It is apparent that two or more functional blocks may be implemented into a single hardware device, and that a single functional block may be implemented through collaboration of two physically separate circuit elements (e.g. a video recorder, a set-top box, a television set, a monitor). Thus, for example, it may happen that in the future two or more functional blocks among the video processor 15 and/or the control module 9 and/or the decoder 1 and/or the data interface control unit 23 are integrated into a single integrated circuit, which nonetheless clearly includes hardware or software modules implementing the invention described herein.

In turn, the control module 9 may be implemented by means of the microprocessor that normally controls the operation of a video reproduction device adapted to implement the present invention. It may be implemented in programmed-logic software or hardware form, or as a special circuit.

It is apparent that the present invention is also applicable to the case wherein the acquisition and storage device is associated or associable with a video recording device, instead of a video reproduction device. This device may be integrated into the same apparatus or associated therewith through a suitable connection interface, whether wired (e.g. HDMI, DVI, Display port, Ethernet) or wireless (e.g. Wi-Fi, WLAN).

It is important to underline that the present invention proves advantageous also in the case wherein the 3D player device can recognize the configuration of the 3D video stream, in that the adopted mechanism may be subject to delays or defects which may be difficult or impossible to overcome. For example, if an image analysis system is employed for obtaining the video stream configuration, said analysis may be very complicated, since it generally demands complex computational processing activities that require much computational power and take quite a long time.

When the configuration is recognized with the help of special metadata entered into the video stream (which technique can be adopted for both back-compatible types), it may happen that the metadata are not recognized due to transmission errors or that they are recognized with a delay because, for example, they are not transmitted frequently enough. In this case, the associated configuration data storage according to the present invention allows making considerably faster the identification of the video configuration and the consequent adaptation of the display apparatus 21 when the tuned program number is changed (especially when the newly selected program belongs to a different mux than the one currently tuned to) or when the configuration changes within the same program at the transition from one transmission to the next, without having to wait for the acquisition of the related metadata contained in the video stream to be reproduced, which might not arrive in time. Similar considerations apply to the fast identification of a generic three-dimensional video stream acquired from an Internet site, recorded from a television program, or directly recorded by a private video camera.

It must be pointed out that the possible coding and transport configurations of television services (sometimes referred to in this description as configuration data) (Side-by side, Side-by-side L/R, Top-bottom) have been described herein in a wholly exemplary and simplified manner: in reality, these configurations can be specified, in general, in one or more fields or sub-fields denoting other features, which the reception/reproduction apparatus may need to know in order to carry out a correct procedure for displaying the video stream in 3D or 2D mode, such as, for example, the initial and/or final resolution of the images, the type of undersampling or decimation applied in the coding stage, the frequency of transfer of the stereoscopic images within the video stream, and the like.

It can therefore be easily understood that what has been described herein may be subject to many modifications, improvements or replacements of equivalent parts and elements without departing from the novelty spirit of the inventive idea, as clearly specified in the following claims.

For example, reference has been made in the present description to three-dimensional vision. It is clear that the present invention is also applicable to the so-called multidimensional systems, wherein the perception of scene depth is given by a large plurality of views of the three-dimensional object.

1. A method for acquiring and storing data relating to a video stream selectable by a user through a video processing apparatus, said method comprising the steps of:
identifying the source of a video stream by means of at least one identification datum, said video stream having a coding and transport configuration adapted to produce a three-dimensional display;
identifying the transport configuration of said video stream through the acquisition of a configuration datum;
establishing, by said video processing apparatus, an association between said at least one identification datum and said configuration datum and storing said association into storage means of said video processing apparatus for a subsequent selection of said video stream.

2. A method according to claim 1, wherein said association is established by using a data structure stored in said storage means by a manufacturer of said video processing apparatus.

3. A method according to claim 2, wherein said association is defined or re-defined through a software update.

4. A method according to claim 1, wherein said configuration datum is acquired automatically.

5. A method according to claim 4, wherein said configuration datum is included in a metadatum associated with said video stream.

6. A method according to claim 4, wherein said configuration datum is obtained by analyzing at least a portion of the decoded video content of the three-dimensional video stream to be identified.

7. A method according to claim 1, wherein said at least one identification datum comprises information identifying a television service and/or the program number under which the television service has been stored in a program table of said apparatus.

8. A method according to claim 1, wherein said configuration datum can be entered by the user through a control unit associated with said video processing apparatus.

9. A method according to claim 8, comprising an interactive procedure wherein the configuration data supported by the video processing apparatus are displayed and the user selects, through said control unit, one of said configuration data to be associated with said at least one identification datum of said video stream.

10. A method according claim 1, wherein said association may be defined or re-defined by the user of said apparatus.

11. A method according to claim 1, wherein said association is represented in table form as a univocal association between said at least one identification datum and said configuration datum contained in a second data structure of a plurality of transport configurations, said second data structure being stored in said storage means.

12. A method according to claim 7, wherein, upon a command for displaying a certain video stream issued by the user through a control unit, said configuration datum associated with said video stream is read from said storage means and is sent to a display control unit.

13. A video stream processing apparatus adapted to generate a video stream which can be reproduced by a display device, said processing apparatus comprising means for implementing the method according to claim 1.

14. An apparatus according to claim 13, wherein said configuration datum is outputted through a data interface, in particular through an HDMI, DVI or display port or a data bus.

15. An apparatus according to claim 13, comprising means for processing a video signal, capable of entering into said reproducible video stream a piece of information associated with said configuration datum in a graphic form that can be recognized by the user.

16. An apparatus according to claim 13, wherein said processing apparatus incorporates said display device.

17. (canceled)
